(19) United States
(12) Patent Application Publication
(10) Pub. No.: US 2013/0132971 A1
(43) Pub. Date: May 23, 2013

(54) SYSTEM, METHOD AND PROGRAM PRODUCT FOR STREAMLINED VIRTUAL MACHINE DESKTOP DISPLAY

(71) Applicants: Marcos Dias De Assuncao, Sao Paulo (BR); Ulysses Lua Moraes Junior, Moema (BR); Andrzej Kochut, Croton on Hudson, NY (US); Jardel Geracci Marceno, Jardim Celeste (BR); Marco Aurelio Stelmar Netto, Sao Paulo (BR)

(72) Inventors: Marcos Dias De Assuncao, Sao Paulo (BR); Ulysses Lua Moraes Junior, Moema (BR); Andrzej Kochut, Croton on Hudson, NY (US); Jardel Geracci Marceno, Jardim Celeste (BR); Marco Aurelio Stelmar Netto, Sao Paulo (BR)

(73) Assignee: INTERNATIONAL BUSINESS MACHINES CORPORATION, Armonk, NY (US)

(21) Appl. No.: 13/302,920

(22) Filed: Nov. 22, 2011

(51) Int. Cl. G06F 9/46

(52) U.S. Cl. 718/105

(57) ABSTRACT

A shared resource system, method of updating client displays and computer program products therefor. At least one client device locally displays activity with resources shared with the client device. A management system on provider computers that is providing resources shared by the client devices selectively generates prioritized display updates. The management system provides updates to respective client devices according to update priority. Updates may also be ordered for network load balancing.

### BACKGROUND OF THE INVENTION

1. Field of the Invention

The present invention is related to shared resource allocation and more particularly to locally displaying and streamlining locally display updates in response to interaction with shared resources.

2. Background Description

Acquiring and managing Information Technology (IT) is a major budgetary concern for any modern organization. Moreover, the local IT hardware is seldom used at full capacity. So to reduce IT infrastructure costs and waste, instead of acquiring physical hardware, organizations increasingly are sharing resources by replacing some local computers with virtual machines (VMs) that run on a remote server computer. Each VM provides a virtual desktop and a display on a client device displays VM desktop activity locally. Each desktop has allocated capacity (e.g. disk space, processing resources and memory) and is configured (software stack and licenses) for its intended purpose and expected needs.

State of the art VM desktop display techniques treat each client as a monitor. Typically, the client interacts with the VM at the server. The server responds in part by modifying the desktop and updates a desktop image that reflects changes to the desktop. The server rasterizes and compresses the desktop image and sends the compressed image to the respective client device for display. The client decompresses the refreshed/updated raster image and displays the image of the updated desktop.

Client devices communicate with the server using specialized remoting protocols. Examples of state of the art remoting protocols include, for example, the Remote Desktop Protocol (RDP) from Microsoft Corporation, see e.g., support.microsoft.com/kb/186607; and the Independent Computing Architecture (ICA) from Citrix Systems, Inc. Both RDP and ICA forward screen updates from the server to the end point device by updating a rectangular area in the client frame buffer. Normally, the server updates images and passes those updates in a manner that is independent of the semantics of the region being updated.

Typically, the server treats each desktop display as a set of raster images and ignores any semantic information that relates screen pixels to the applications they represent. The server usually changes/updates the image area temporally, sequentially, in the order the updates are made at the server. For protocols that support media redirection, the server redirects media playback from the server to the client, forwarding encoded multimedia content to the end point client device in sequence. The client device decodes and renders the multimedia data stream with the rest of the client display screen, e.g., forwarded using screen region updates. So, sequentially updating frame images is satisfactory for streamed multimedia.

Most state of the art graphics remoting protocols treat virtual displays as a set of raster images and ignore semantic information that relates screen pixels to active applications. There are a few media streaming approaches that include update commands with media control commands, including WYSE TCX Extensions from Wyse Technology Inc., HDX MediaStream Flash Redirection from Citrix Systems, Inc. and Windows Media Redirection from Microsoft Corporation. However, even these media streaming approaches fail to relate client display content to application activity on the respective VM.

Consequently, existing solutions use brute force techniques making any and all screen updates in each transfer, to render VM desktop updates on local desktop displays, ignoring individual application latency, responsiveness and user performance expectations. This brute force approach regenerates, compresses and usually transfers the entire raster image for each desktop, regardless of whether some applications are changing faster than the updates or, some or none of the applications are unchanged such that updates are necessary. Latency from updating too infrequently to match application changes provides a local experience that falls far short of what one experiences using a physical desktop machine physically located near the user. Updating frequently when display updates are unwarranted, however, wastes resources, i.e., processing power to rasterize, compress and decompress, as well as network bandwidth transferring updates. This is a costly inefficiency inherent in using virtual desktops in state of the art remoting protocols employed in cloud computing.

Thus, there is a need for rendering VM desktops on local desktop displays with reduced latency for improved responsiveness, to meet users' performance expectations, and while conserving computing resources used in unnecessary updates; and more particularly, there is a need for prioritizing and customizing screen update transfers at refresh rates that minimize latency for each user and for load balancing.

### SUMMARY OF THE INVENTION

A feature of the invention is prioritized virtual desktop display updates provided to local client displays;

Another feature of the invention is virtual desktop display updates prioritized for reduced latency and improved responsiveness for transfer to client displays;

Yet another feature of the invention is streamlined transfer of prioritized virtual desktop display updates to local client displays;

Yet another feature of the invention is streamlined transfer of prioritized virtual desktop display updates to local client displays, prioritized responsive to user interaction and application type.

The present invention relates to a shared resource system, method of updating client displays and computer program products therefor. At least one client device locally displays activity with resources shared with the client device. A management system on provider computers that is providing resources shared by the client devices selectively generates prioritized display updates. The management system provides updates to respective client devices according to update priority. Updates may also be ordered for network load balancing.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 depicts a cloud computing node according to an embodiment of the present invention;

FIG. 2 depicts a cloud computing environment according to an embodiment of the present invention;

FIG. 3 depicts abstraction model layers according to an embodiment of the present invention;

FIG. 4 shows an example of the target computing environment for application to a preferred embodiment of the present invention;

FIGS. 5A and B show an example of management system components for display management load balancing, and refreshing user displays by the management system components;

FIGS. 6A and B show examples of a frame priority table and an application list;

FIG. 7 shows the operation of a preferred Frame Analyzer.

### DESCRIPTION OF PREFERRED EMBODIMENTS

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed and as further indicated hereinbelow.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service. Moreover, the present invention provides for client self-monitoring for adjusting individual resource allocation and configuration on-the-fly for optimized resource allocation in real time and with operating costs and energy use minimized.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources, sometimes referred to as a hypervisor, where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

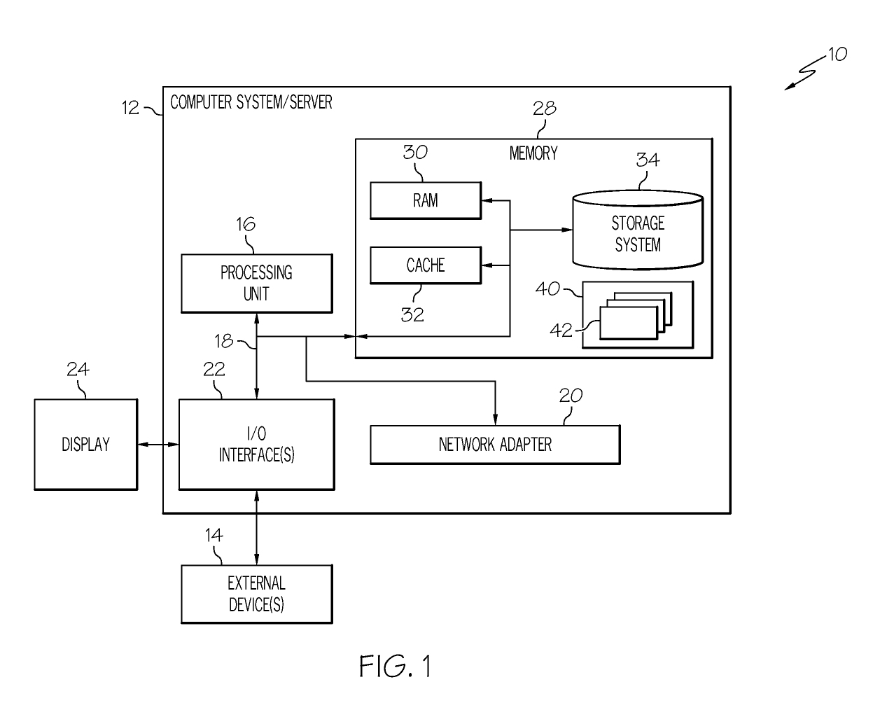

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

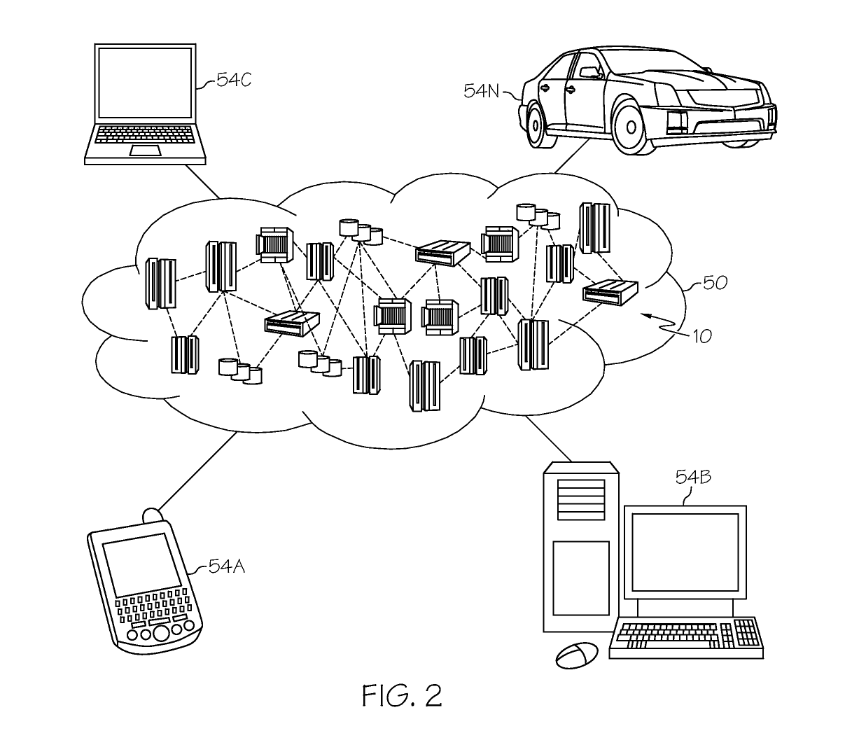

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

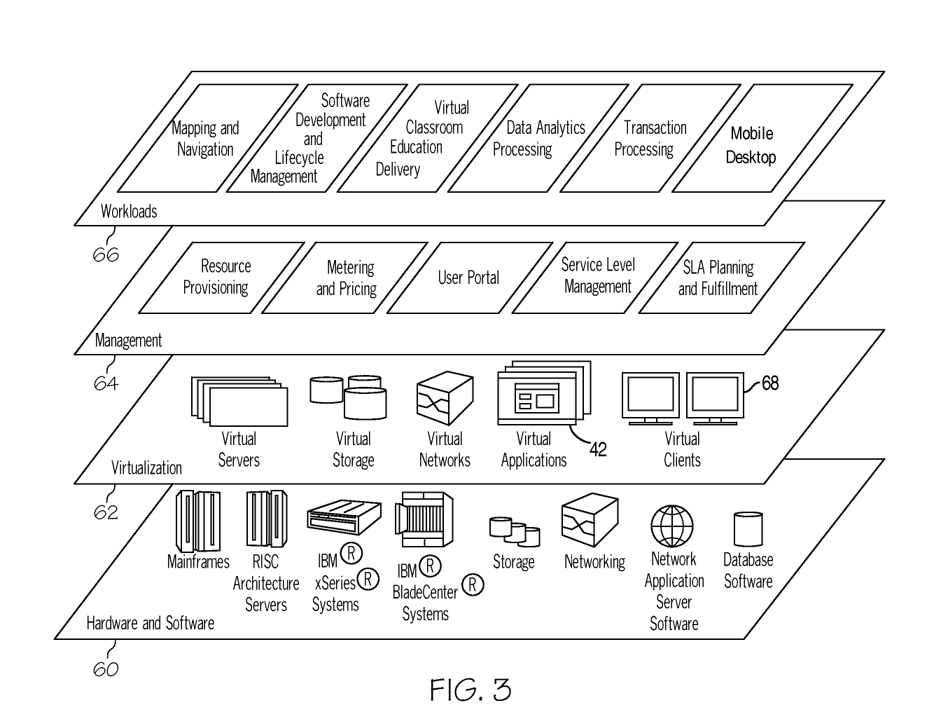

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and Mobile Desktop.

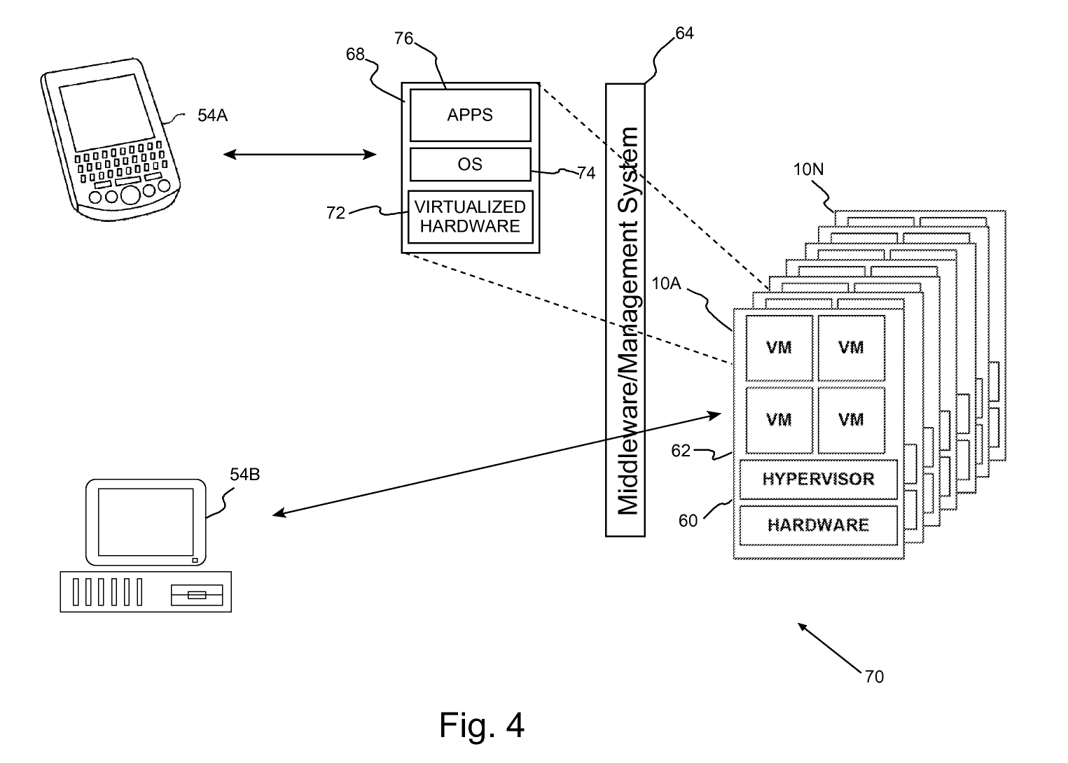

FIG. 4 shows an example of the target computing environment 70 for application to a preferred embodiment of the present invention with reference to the cloud environment of FIGS. 1-3 with like features labeled identically. In the preferred computing environment 70 users at devices 54A, 54B interface with virtual machines 68 on networked servers 10A-10N using network messages in a preferred Remoting Graphics Protocol (RGP). Each virtual machine 68 includes virtualized hardware 72, an operating system(s) 74 and applications 76, and is hosted by a respective server, 10A in this example. A preferred management system 64 in middleware runs on or cooperates with servers 10A-10N allocating resources, modifying each respective VM desktop in response to, e.g., user interaction at respective device 54A, 54B, VM application 76 activity, and etc., and providing prioritized desktop updates for local display at each respective device 54A, 54B.

Thus, according to a preferred embodiment of the present invention, the preferred management system 64 characterizes applications 76 according to user interaction. The preferred management system 64 verifies how each user is interacting with applications 76 through a respective device 54A, 54B and for each application determines responsiveness and latency expectations. Then, the preferred management system 64 prioritizes display updates to devices 54A, 54B based on that determination and characteristics of applications 76 currently executing on respective virtual machine 68 desktops.

Thus, the preferred management system 64 provides application specific refresh rates at devices 54A, 54B, with display updates customized to each active application 76. Each active application 76 on each device 54A, 54B, may be associated with a different refresh rate. So, for example, interactive applications with an expectation of better responsiveness or critical needs applications are refreshed faster and more frequently for minimized latency; while applications, where such considerations are less important, are updated less frequently to conserve system resources and bandwidth and to free computing resources for other applications. Accordingly, application of the present invention streamlines updating client displays and optimizes computing resource use.

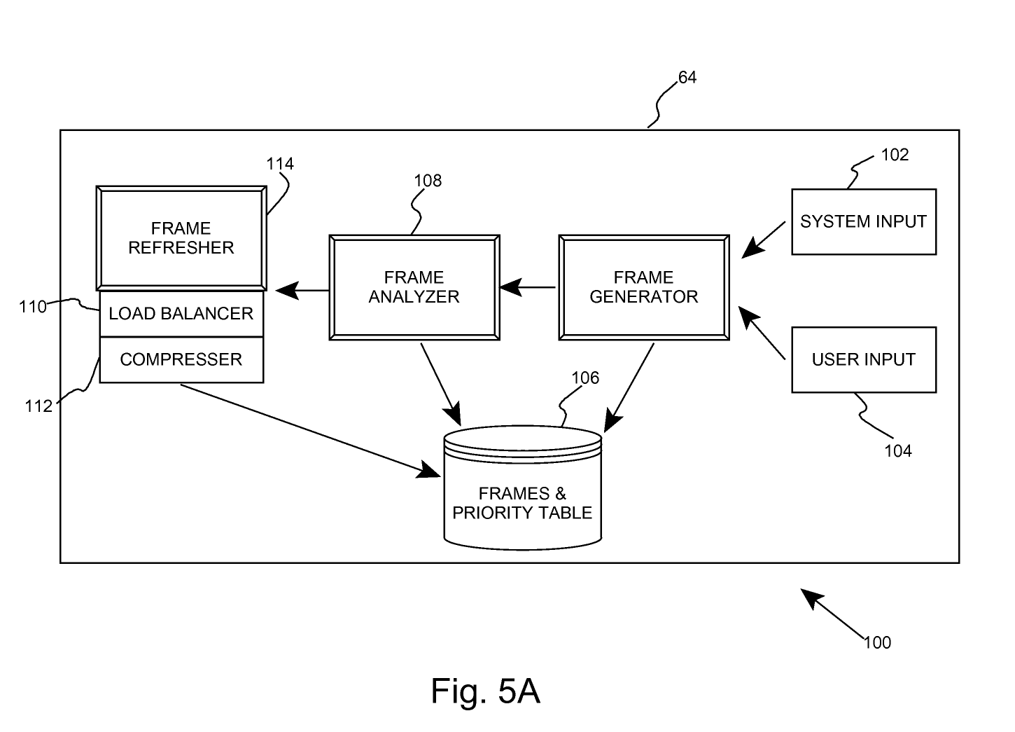

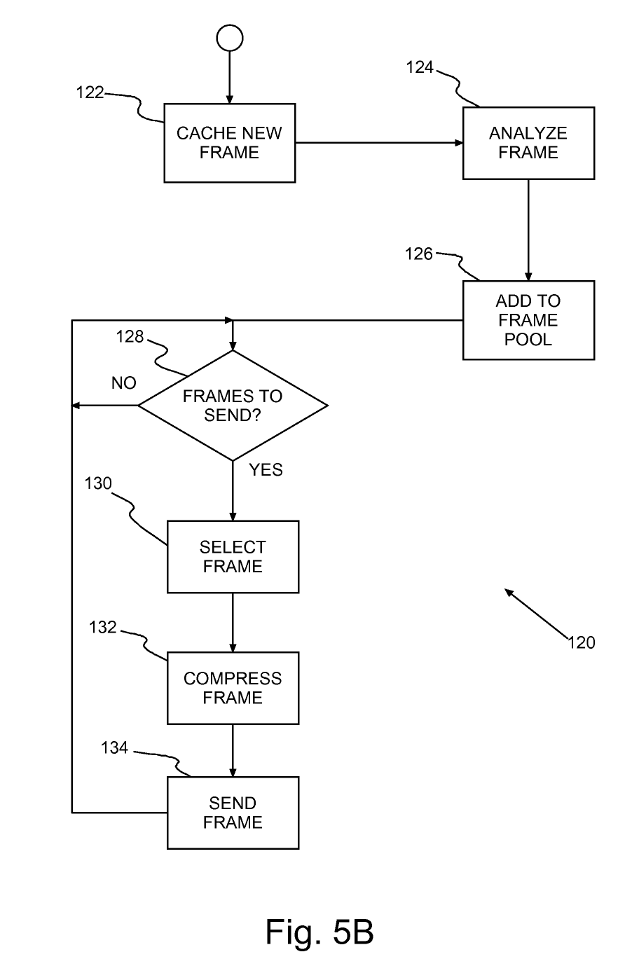

FIGS. 5A and B show an example of management system 64 components for streamlined VM display updates and load balancing, and for refreshing user displays 120 by the management system 64 components, according to a preferred embodiment of the present invention. As shown in FIG. 5A, a Frame Generator 100 generates frames based on system input 102 and/or user input 104 and caches generated frames in storage 106. A Frame Analyzer 108 prioritizes cached frames. A load balancer 110 uses a load balancing policy for each frame. A compressor 112 encodes frames for transfer. Guided by a respective load balancing policy, a Frame Refresher 114 in selectively forwards prioritized, compressed frames to user devices 54A, 54B.

As shown in FIG. 5B, updates begin when the Frame Generator 100 generates a frame in response to resource activity, e.g., user or application activity. The Frame Generator 100 caches the new frame 122 in a frame pool in storage 106. The Frame Analyzer 108 analyzes 124 each frame, considering semantic information regarding application type and user interaction, prioritizes with a respective load balancing policy and re-caches 126 the frame to the frame pool 106. As the Frame Analyzer 108 caches prioritized frames, the Frame Refresher 114 forwards prioritized frames to user devices 54A, 54B according to assigned priority. The Frame Refresher 114 monitors the frame pool 106 for prioritized frames 128. If frames are available, the Frame Refresher 114 selects 130 a priority frame for optional load balancing 110 according to frame priorities and network conditions provided in the respective load balancing policy. Then, Frame Refresher 114 forwards 132 the frame for compression 112, optionally, to minimize network bandwidth. Then, the Frame Refresher 114 sends 134 the compressed frame to the respective user device 54A, 54B.

So, the Frame Generator 100 receives system input 102 and/or user input 104 and generates raw updated frames, which it temporarily caches 122 in storage 106. The storage 106 also includes a frame priority table with priority policies assignable to each cached frame and for indicating application interactions 102 and interaction 104 with each user device 54A, 54B.

System input 102 may include application alerts and application interaction and, further, may be grouped according application interaction. Thus, for example, graphical application may be grouped with High Interaction Applications (HIAs), messaging applications may be grouped with Low Interaction Applications (LIAs), and video streaming may be grouped with Real Time Applications (RTAs). Optionally, a system administrator may create other classifications, e.g., for applications based on interaction demand.

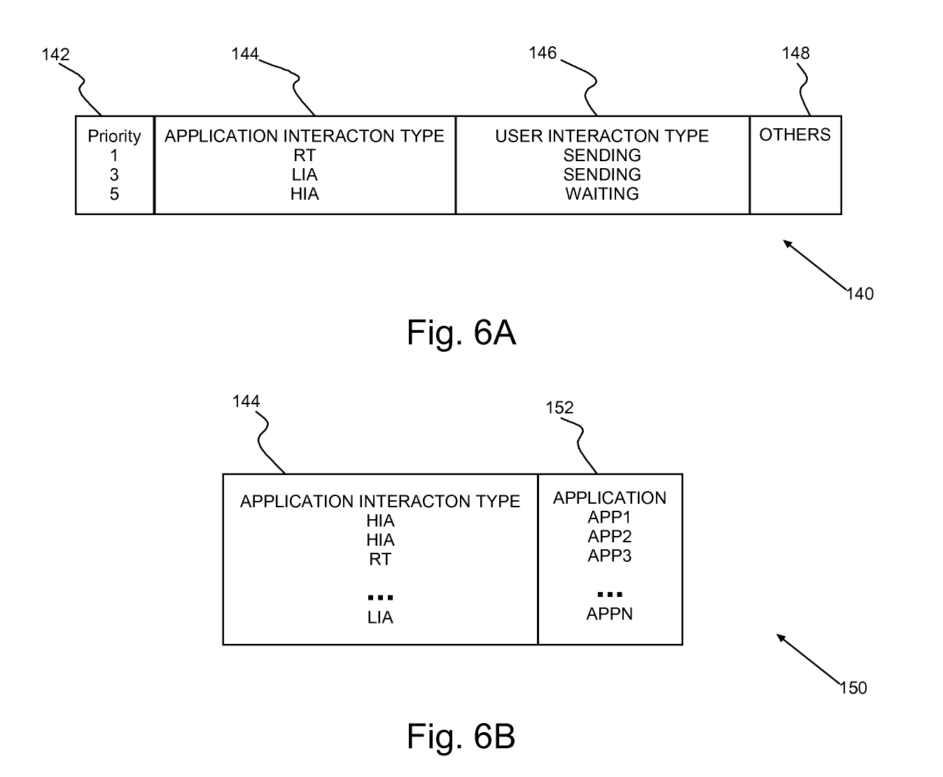

FIGS. 6A and B show examples of a frame priority table 140 with assignable priority policies and an application list 150 connecting applications with application type. In this example, each entry in the frame priority table 140 includes a field for frame Priority 142 (<ID>), Application Interaction Type 144 (<RT,LIA,HIA>), User Interaction type 146 (<Sending,Waiting>), and Others 148 (<any>).

The additional application list 150 describes Application Interaction Type 144 and connects application information with the Application Interaction Type 144. So in this example, the application list 150 indicates Application Interaction Type 144 (<RT,LIA,HIA>), and an Application name 152.

Typical user inputs 104 or user interaction types express how users are currently interacting with the application. So in particular, possible interaction types include sending and waiting. Sending includes, for example, sending interaction with a device 54A, 54B, such as from a mouse, a keyboard, a touch screen and/or voice input. Waiting includes waiting for input coming from the operating system, which could be triggered by network data or data processing.

Returning to FIGS. 5A and B, the Frame Analyzer 108 analyzes 124 and prioritizes raw frames generated by the Frame Generator 100. Preferably, the Frame Analyzer 108 assigns priorities to applications in reliance on parameters in the frame priority table 140. Typically, a system administrator configures the frame priority table 140. Preferably, the frame priority table 140 includes at least priority identifiers 142, application interaction types 144, and user interaction types 146. The Frame Analyzer 108 prioritizes each cached frame from the priority table 140 according to activity by the displayed applications and a user priority selected according to user interaction 146 at user input 104.

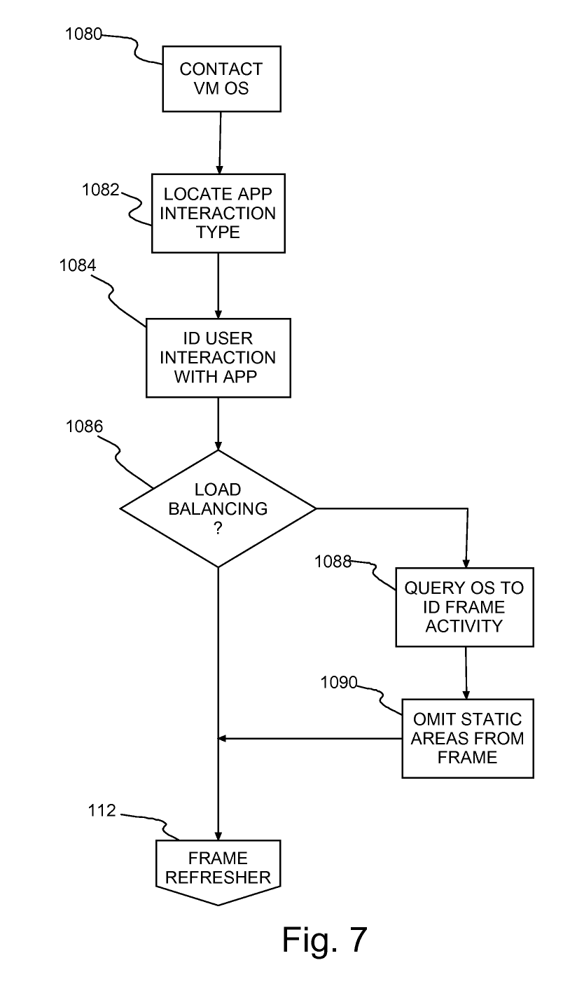

FIG. 7 shows operation of a preferred Frame Analyzer 108. Primarily, the Frame Analyzer 108 begins by contacting 1080 the respective VM operating system to discover which application is interacting with the respective user device 54A, 54B. Then, the Frame Analyzer 108 locates 1082 the application interaction type (144 in FIGS. 6A and B) in the application list 150. Next the Frame Analyzer 108 identifies 1084 the VM operating system how the user is interacting 146 with the application, i.e., sending or waiting.

Optionally, Frame Analyzer 108 may selectively sample the frames, instead of analyzing all frames individually. Also, the Frame Analyzer 108 can prioritize application types based on past user experience from historical data. The Frame Analyzer 108 can also discard irrelevant frames in consideration of user expectations about a given application. Alternately, for a given user the Frame Analyzer 108 can use configuration data to quickly and efficiently verify business value in refreshing a given application.

Further, if insufficient network bandwidth is available, the Frame Analyzer 108 can further optimize 1086 to reduce the data transferred in each frame. Alternately, the compressor module can optimize 1086 to reduce bandwidth in the data transfers, e.g., by limiting update transfers to the change between sequential frames. The Frame Analyzer 108 can begin optimization by querying 1088 the operating system to identify specific locations or portions of the application window. Then, the Frame Analyzer 108 essentially crops the image to changes, e.g., selecting 1090 only the change areas, and omitting the remaining areas from the frame, to limit the data being transferred to cropped images with actual changes within the frame.

The Frame Refresher 114 uses the compressor 112 to compress 132 the frames, and sends 134 compressed frames to user devices 54A, 54B, guided by the load balancer 110. The load balancer 110 generates a load balancing policy 130 for each frame based on frame priority, user priority and network conditions. Network conditions considered by the load balancer 110 can include, for example, latency, available bandwidth and projected network traffic. The Frame Refresher 114 forwards frames selected based on, for example, round-robin selection for low priority frames, assigned high priority to high-interaction application frames, and/or using video streaming priority algorithms. The frame compressing mechanism in compressor 112, may be in hardware or software encoding, and may use any suitable compression algorithm. Suitable compression algorithms include, for example, the CopyRect, RRE, Hextile, and ZRLE functions of the well-known Remote Frame Buffering (RFB) protocol.

Advantageously, the present invention streamlines maintaining VM desktop displays up to date on client devices. Local display update frequency is tailored to VM desktop change activity. Applications that exhibit little desktop activity or, that may be dormant, do not trigger unnecessary updates; while updates for applications actively changing the desktop are transferred contemporaneously or in real time. Moreover, updates may be limited only to actual desktop changes to minimize network bandwidth consumed. Thus, user devices are updated contemporaneously to provide users with an effective high virtual refresh rate for all applications, and especially for applications that make frequent desktop changes in response to application activity, or in response to user interaction and/or giving priority for more business critical applications.

While the invention has been described in terms of preferred embodiments, those skilled in the art will recognize that the invention can be practiced with modification within the spirit and scope of the appended claims. It is intended that all such variations and modifications fall within the scope of the appended claims. Examples and drawings are, accordingly, to be regarded as illustrative rather than restrictive.

What is claimed is:

1. A shared resource system comprising:
a plurality of client devices, at least one client device having a display locally displaying activity with resources shared with said at least one client device;
one or more provider computers providing resources shared by said plurality of client devices;
a network connecting said plurality of client devices to said one or more provider computers, said plurality of client devices and said one or more provider computers passing messages to each other over said network; and
a management system on at least one provider computer, said management system selectively generating prioritized display updates, said prioritized display updates being provided to respective said plurality of client devices responsive to update priority.

2. A shared resource system as in claim 1, said management system comprising:
a frame generator generating display updates;
a frame analyzer prioritizing said display updates, and a frame refresher encoding said display updates and selectively providing said display updates to respective said plurality of client devices responsive to update priority.

3. A shared resource system as in claim 2, said management system further comprising:
a frame storage storing generated display updates and a priority table;
a compressor compressing selected prioritized frames; and
a load balancer generates a load balancing policy for each frame.

4. A shared resource system as in claim 3 operating in a cloud environment, wherein said load balancer generates each said load balancing policy responsive to frame priority, user priority and network conditions.

5. A shared resource system as in claim 3, wherein said priority table comprises for each frame a field indicating frame priority, application interaction type, and user interaction type.

6. A shared resource system as in claim 5, wherein for said each frame said application interaction type is selected from a High Interaction Application (HIA) type, a Low Interaction Application (LIA) type, and a Real Time Application (RTA) type, and user interaction type is selected from Sending and Waiting.

7. A shared resource system as in claim 5, wherein said frame storage further stores an application list connecting application information with application interaction types.

8. A method of updating a display, said method comprising:
sharing amongst one or more client devices computer resources on one or more provider computers;
interacting with shared said computer resources, each said client device interacting with said shared computer resources through a virtual machine (VM), a VM desktop being displayed at said each client device, each VM desktop changing responsive to shared resource activity;
prioritizing client device display updates; and
forwarding desktop updates to respective said client devices responsive to said update prioritization.

9. A method of updating a display as in claim 8, wherein said shared resource activity comprises client device input and provider computer input to a shared resource.

10. A method of updating a display in a cloud environment as in claim 8, prioritizing updates comprising:
generating an updated frame for a respective client device responsive to said shared resource activity;
analyzing said updated frame and assigning a priority to said updated frame responsive to analysis results; and
compressing said updated frame, the compressed frames being forwarded for display on said respective client devices according to assigned priority.

11. A method of updating a cloud client display as in claim 10, analyzing updated frames comprising:
discovering from each respective VM operating system which shared application is interacting with the respective cloud client device;
locating an application interaction type in an application list; and
identifying user interaction with the shared application.

12. A method of updating a cloud client display as in claim 11, wherein an entry is made for each updated frame prioritizing the respective updated frame responsive to said located application interaction type and said identified user interaction.

13. A method of updating a cloud client display as in claim 11, wherein said application interaction type is selected from a High Interaction Application (HIA) type, a Low Interaction Application (LIA) type, and a Real Time Application (RTA) type, and said user interaction type is selected from Sending and Waiting.

14. A method of updating a cloud client display as in claim 10, wherein prioritizing updates further comprises ordering frames for load balancing responsive to network load.

15. A method of updating a cloud client display as in claim 14, wherein load balancing comprises selecting frames based on:
using round-robin selection for low priority frames;
assigning high priority to high-interaction application frames; and
video streaming priority algorithms.

16. A computer program product for updating a display, said computer program product comprising a computer usable medium having computer readable program code stored thereon, said computer readable program code comprising:
computer readable program code means for providing shared resources to a plurality of client devices;
computer readable program code means for receiving frames for display on respective ones of said plurality of client devices;
computer readable program code means for analyzing received frames;
computer readable program code means for assigning priority to each analyzed frame; and
computer readable program code means for selecting and forwarding analyzed said frames to said respective ones according to frame priority.

17. A computer program product for updating a display in a cloud environment as in claim 16, wherein said plurality of client devices are cloud client devices, said computer readable program code further comprising:
computer readable program code means for generating display updates;
computer readable program code means for prioritizing said display updates; and
computer readable program code means for encoding said display updates and selectively providing said display updates to respective said plurality of cloud client devices responsive to update priority.

18. A computer program product for updating a display as in claim 17, said computer readable program code further comprising:
computer readable program code means for storing generated display updates, a priority table and an application list connecting application information with application interaction types;
computer readable program code means for compressing prioritized frames; and
computer readable program code means for generating a load balancing policy for each frame.

19. A computer program product for updating a display as in claim 18, wherein said computer readable program code means for generating a load balancing policy generates each said load balancing policy responsive to frame priority, user priority and network conditions.

20. A computer program product for updating a display as in claim 18, wherein said priority table at least includes for each frame a field indicating frame priority, application interaction type, and user interaction type; and, wherein for said each frame said application interaction type is selected from a High Interaction Application (HIA) type, a Low Interaction Application (LIA) type, and a Real Time Application (RTA) type, and user interaction type is selected from Sending and Waiting.

21. A computer program product for updating client displays in a cloud environment, said computer program product comprising a computer usable medium having computer readable program code stored thereon, said computer readable program code causing a computer executing said code to:
share cloud resources on one or more provider computers, said cloud resources being shared amongst one or more cloud clients, each cloud client interacting with said shared computer resources through a virtual machine (VM) and locally displaying a copy of said VM desktop, each VM desktop changing responsive to shared resource activity;
monitor interaction with shared said computer resources for changes to VM desktops;
prioritize each update for cloud client displays; and
forward VM desktop updates to respective said cloud clients responsive to said update prioritization.

22. A computer program product for managing allocation of resource capacity as in claim 21, wherein shared resource interaction comprises client device input and provider computer input and prioritizing updates comprises said computer readable program code causing a computer executing said code to:
generate an updated frame for a respective client device responsive to said shared resource activity;
analyze said updated frame and assign a priority to said updated frame responsive to analysis results; and
compress said updated frame, the compressed frames being forwarded for display on said respective cloud clients according to assigned priority.

23. A computer program product for managing allocation of resource capacity as in claim 22, wherein analyzing updated frames comprises said computer readable program code causing a computer executing said code to:
discover from each respective VM operating system which application is interacting with the respective cloud client;
locate an application interaction type in an application list; and
identify user interaction with the application.

24. A computer program product for managing allocation of resource capacity as in claim 23, wherein said computer readable program code causing a computer executing said code to:
make an entry for each updated frame; and
prioritize the respective updated frame responsive to said located application interaction type and said identified user interaction; and,
wherein said application interaction type is selected from a High Interaction Application (HIA) type, a Low Interaction Application (LIA) type, and a Real Time Application (RTA) type, and said user interaction type is selected from Sending and Waiting.

25. A computer program product for managing allocation of resource capacity as in claim 21, wherein prioritizing updates further causing said computer executing said code to order frames for load balancing comprises selecting frames based on:
using round-robin selection for low priority frames;
assigning high priority to high-interaction application frames; and
video streaming priority algorithms.
